(19) United States
(12) Patent Application Publication
(10) Pub. No.: US 2007/0080053 A1
(43) Pub. Date: Apr. 12, 2007

(54) Method and apparatus for deposition of films of coating materials, in particular of superconductive oxides

(75) Inventors: Alberto Baldini, Firenze (IT); Andrea Gauzzi, Parma (IT); Sergio Zannella, Mariano Comense (IT)

Correspondence Address: VENABLE LLP, P.O. BOX 34385, WASHINGTON, DC, 20043-9998, US

(73) Assignee: Edison S.P.A., Milano (IT)

(21) Appl. No.: 10/571,461

(22) PCT Filed: Sep. 10, 2004
(86) PCT No.: PCT/IB04/02960

§ 371 Date: Dec. 20, 2006

(30) Foreign Application Priority Data
Sep. 11, 2003 (IT) TO2003A000690

(51) Int. Cl. H05F 3/00

(52) U.S. Cl. 204/164

(57) ABSTRACT

There are provided herein a method and an apparatus for deposition of films of coating materials on a substrate, of particular use in obtaining superconductive composite tapes for deposition of films of superconductive oxides and/or buffer layers. A step of deposition of the film on the substrate is associated to a step of gas treatment in situ, in which a flow of gas is sent towards a working surface of the substrate or of the film growing on the substrate. The gas-treatment step is performed via ultrasound-expansion nozzles.

### TECHNICAL FIELD

The present invention relates to a method and an apparatus for deposition of films of coating materials, in particular for deposition of films of superconductive oxides and/or buffer layers in processes of fabrication of superconductive composite tapes.

### BACKGROUND ART

The possibility of large-scale production of YBCO or REBCO superconductive films deposited on flexible metal tapes is of considerable industrial interest. The fabrication of these materials requires a complete in situ oxidation of the superconductive films, so as to limit the oxygen defect to a value lower than 0.1.

In the common case of vacuum-deposition techniques, the need to oxidize the superconductive film requires a local increase, on the surface of the film being grown, of the effective oxygen pressure with respect to the mean oxygen partial pressure within the vacuum chamber.

A device for in situ oxidation associated to a thermal co-evaporation is known, for example, from the DE-A-19631101: oxidation is ensured by cyclic passage of an oxygen diffuser over the surface of the film being grown; the diffuser is box-shaped, and the oxygen flows out from the inside of the box; the box has the function of delaying the outlet of the oxygen molecules from the area of growth of the film, with a consequent increase in the effective oxygen pressure with respect to the partial pressure in the rest of the vacuum chamber.

The above device and other similar systems present, however, the serious drawback that, in order to ensure a significant increase in oxygen pressure, they entail maintaining the edges of the box at a very small distance from the surface of the film being grown (in the region of a tenth of a millimetre). It is consequently necessary to envisage not only an accurate initial adjustment of the position of the diffuser, but also a continuous and accurate control of the distance of the diffuser from the surface of the film being grown during deposition. To ensure effective operation of this type of devices, it is hence necessary to envisage complex systems of tightness and/or refined systems of mechanical positioning. In any case, there is not a fully satisfactory reliability of the process. In deposition processes of different type, for example by spraying, cluster beam, powder or particles coating as described in DE-4408052-C1, DE-3610294-A1, GB2175414-A), it is known to suspend the deposition material in a ultrasonic gas flow.

### DISCLOSURE OF INVENTION

A purpose of the present invention is to provide a method and an apparatus for deposition of films of coating materials, in particular for deposition of films of superconductive oxides and/or buffer layers in processes of fabrication of superconductive composite tapes, which will be free from the drawbacks of the known art referred to above. In particular, a purpose of the invention is to provide a method and an apparatus that will also enable continuous operation at high processing rates, ensuring an effective deposition and a high reliability and presenting at the same time a simple and economically advantageous embodiment.

In accordance with said purposes, the present invention relates to a method and an apparatus as defined in the annexed claims 1 and 13, respectively.

The method and apparatus according to the invention enable a significant increase in the effective oxygen pressure to be achieved in the deposition area, so that said oxygen pressure is comparable to the one that can be obtained with available systems, but without any need for complex constructional and process solutions of known systems. The flow of oxygen can in fact be delivered at a distance decidedly greater than what occurs in known systems, i.e., one in the region of a few millimetres as against the tenths of millimetre required by known systems.

Consequently, the moving systems can be simpler and require a lower accuracy of construction and operation. It is also possible to carry out the deposition and oxygenation steps at high rates. Finally, a significant increase in the production rate and in the reliability of the process is obtained, with a consequent reduction in the overall production costs.

The gas-treatment step can be performed not only with oxygen but also with other types of gas that perform other functions: for example, the gas supplied can be a forming gas (for example, an argon/hydrogen mixture) or any other type of reactive gas.

### BRIEF DESCRIPTION OF THE DRAWINGS

Further characteristics and advantages of the present invention will emerge clearly from the ensuing description of a non-limiting example of embodiment thereof, with reference to the figures of the annexed drawings, in which:

FIG. 1 is a schematic illustration of a first embodiment of the apparatus according to the invention;

FIG. 2 is a schematic illustration of a detail, at an enlarged scale, of the apparatus illustrated in FIG. 1; and

FIGS. 3 and 4 are a side view and a sectioned view, respectively, of a second embodiment of the apparatus according to the invention.

### BEST MODE FOR CARRYING OUT THE INVENTION

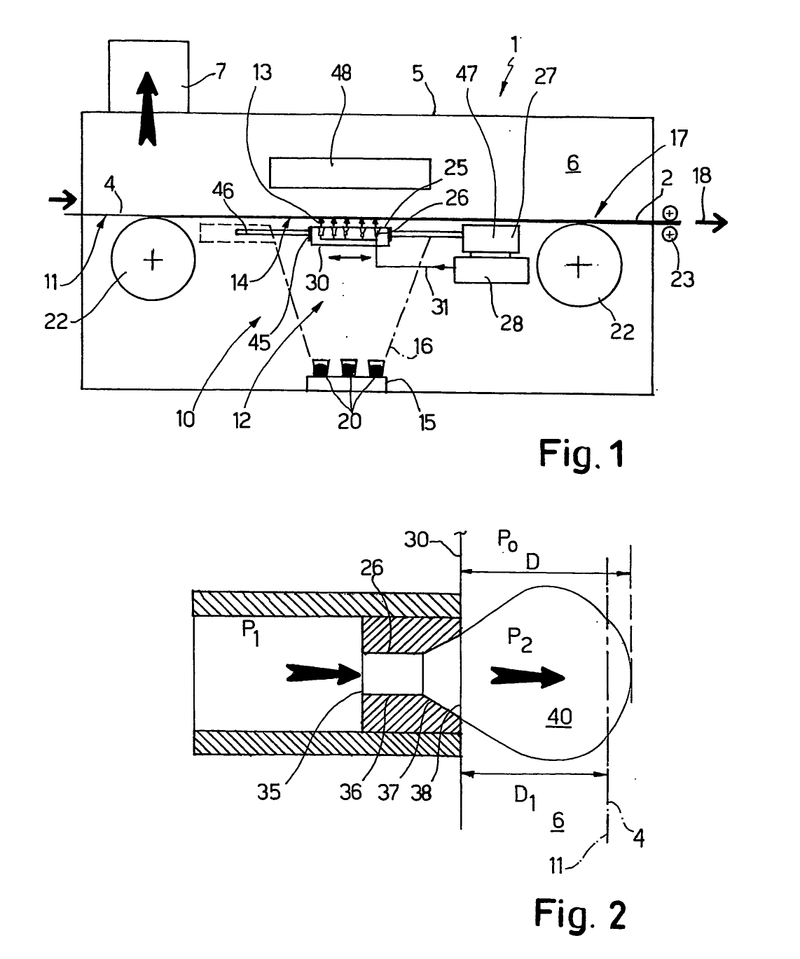

In FIG. 1, designated as a whole by 1 is an apparatus for deposition of films of coating materials and, in particular, for deposition of films of superconductive oxides and/or buffer layers in processes of fabrication of superconductive composite tapes. The apparatus 1 is a continuous-treatment apparatus for forming a film 2 (which may be, in particular, a film of one or more superconductive oxides, or else a so-called buffer layer) on a substrate 4 in the form of a tape.

The apparatus 1 comprises a casing 5 delimiting, on the inside, a vacuum chamber 6 provided with at least one suction pump 7 for bringing the internal pressure of the chamber 6 to a pre-fixed value P₀ in the region of 10⁻⁵ mbar.

Housed inside the chamber 6 are deposition means 10 for forming the film 2 on a face 11 of the substrate 4, and gas-treatment means 12 for delivering a flow of gas, indicated by the arrows 13 in FIG. 1, onto a working surface 14 of the substrate 4 or of the film 2 growing on the substrate 4.

The deposition means 10, according to a technology commonly employed in the sector, comprise evaporation means 15 for forming an evaporation area 16 within the chamber 6, and continuous-feed means 17 for feeding continuously the substrate 4 into the chamber 6 and through the evaporation area 16 in a direction of advance 18. In particular, the evaporation means 15 comprise a series of electrically heated crucibles 20 for evaporating suitable precursors of the elements necessary for formation of the film 2. Said evaporated elements form the evaporation area 16 and are deposited on the face 11 of the substrate 4 facing the crucibles 20. It remains understood that the apparatus 1 can include evaporation means 15 of other types and, more in general, deposition means 10 of any known type.

Also the feed means 17 for feeding the substrate 4 can be of any known type and are only schematically represented in FIG. 1 by: a pair of rollers 22, which are set in a direction transverse to the substrate 4 and support the substrate 4 above the evaporation area 16; and drawing rollers 23, which move the substrate 4 in the direction of advance 18.

The gas-treatment means 12 comprise at least one gas diffuser 25 provided with one nozzle 26 or, preferably, a plurality of nozzles 26, and moving means 27 for moving the diffuser 25 within the evaporation area 16. Pressurization means 28 (in themselves known) are envisaged for feeding gas under pressure, in particular at an inlet pressure P₁ of approximately 2 atm, to the diffuser 25.

The diffuser 25 comprises a box-like body 30 connected via a pipe 31 to the pressurization means 28 or, more in general, to a pressurized-gas source. Formed inside the body 30 are the nozzles 26, which are connected in parallel to the pipe 31.

According to the type of treatment to be carried out, the gas may be oxygen or any other type of reactive gas, for example a forming gas, such as an argon/hydrogen mixture.

With reference also to FIG. 2, the nozzles 26 are ultrasound-expansion nozzles, i.e., nozzles designed to generate an ultrasound expansion of the gas flow that traverses them. Each nozzle 26 is thus shaped and subjected to a pressure difference between the inlet and the outlet of the nozzle such that the gas flow sent through the nozzle is delivered while undergoing ultrasound expansion and, in particular, an adiabatic ultrasound expansion.

By the term “ultrasound-expansion nozzle” is therefore meant a nozzle shaped in such a way that, in the presence of a given and sufficiently high pressure difference between the inlet and the outlet of the nozzle, the gas flow that traverses the nozzle undergoes an expansion, with consequent increase of the speed to supersonic values.

Each nozzle 26 has an inlet 35, which is connected to the pipe 31 and has an inlet section smaller than the cross section of the pipe 31. Each nozzle 26 comprises, starting from the inlet 35, a stretch 36 of groove with constant cross section, having a cross section of groove substantially equal to the inlet cross section, and a divergent stretch 37 terminating with an outlet 38 having an outlet cross section greater than the groove cross section, i.e., than the inlet cross section. Each nozzle 26 has a ratio between the inlet cross section and the outlet cross section comprised between approximately 1:2 and approximately 1:20.

Each nozzle 26 is designed to generate a gas-delivery area 40, in which at least as far as a distance D of approximately 5 mm, and even as far as a distance of approximately 10 mm, from the outlet 38 of the nozzle 26 there is an outlet pressure P₂ that is at least ten times the pressure P₀ in the chamber 6. In other words, each nozzle 26 is designed to generate a gas-delivery area, in which, at least as far as a distance D of approximately 5 mm (and even as far as a distance of approximately 10 mm) from the outlet 38 of the nozzle 26, there is an oxygen pressure at least ten times the oxygen pressure in the chamber 6.

In this way, a significant increase of the oxygen pressure in the area of interest is obtained, without any alteration of the pressure in the chamber 6.

The diffuser 25 is set underneath the face 11, with the nozzles 26 set substantially orthogonal to the face 11. The outlets 38 of the nozzles 26 are set at a distance D₁ smaller than the distance D from the face 11. Since the gas-delivery area is relatively wide (i.e., the distance D is relatively large, in the region of a few millimetres), also the distance D₁ can be relatively large, for example larger than 1 mm but even, if so required, larger than 2 mm or 3 mm, and in particular comprised between approximately 3 mm and 5 mm.

The moving means 27 can be of any type; for example, the moving means 27 comprise a slide 45, on which the diffuser 25 is installed and which is slidable on a guide 46 parallel to the direction of advance 18. The slide 45 is moved by an actuator 47 so as to bring the diffuser 25 cyclically within the evaporation area 16.

The apparatus 1 also comprises a device 48 for heating the substrate 4, for example with IR lamps or electrical heating means. The device 48 is set above the substrate 4 on the side opposite to the face 11 and to the evaporation area 16.

Operation of the apparatus 1 embodying the method according to the invention is described in what follows.

The substrate 4 in the form of a tape is fed continuously through the chamber 6, in which the pressure is maintained at the pre-set value P₀, and there is hence a relatively low partial pressure of oxygen. Whilst the substrate 4 traverses the chamber 6, an evaporation step is performed, in which the evaporation area 16 is formed. The substrate 4 traverses the evaporation area 16, where a step of deposition of the film 2 on the face 11 is carried out.

Associated to the deposition step is a step of gas treatment in situ, which, in the case in point, is a step of oxygenation performed during the same deposition step and in which the flow 13 (flow of oxygen) is sent towards the working surface 14 (i.e., the surface of the film 2 growing on the substrate 4). The step of gas treatment (oxygenation) is performed via the diffuser 25 provided with the ultrasound-expansion nozzles 26 and consequently comprises a step of ultrasound expansion, and specifically a step of adiabatic ultrasound expansion, of the delivered gas flow 13.

The flow 13 is sent to the diffuser 25 at the inlet pressure P₁, indicatively around 2 atm, and the gas-treatment step hence comprises, prior to the step of ultrasound expansion, a step of pressurization of the flow 13.

Advantageously, the step of gas treatment (oxygenation) is performed cyclically, bringing the diffuser 25 cyclically into the evaporation area 16 via the moving means 27.

It remains understood that the apparatus 1 is suited for use, not only with a flow 13 of oxygen, but also with other types of gas. Hence, according to possible variants of the method according to the invention, in the gas-treatment step, instead of oxygen, other types of gas are delivered, for carrying out different and specific functions, for example heating, cleaning, or in any case treatment of the working surface 14 (which may be, according to the treatment, the surface of the substrate 4 or the surface of the film 2 growing on the substrate).

In particular, the gas flow is a flow of reactive gas such as a forming gas, for example an argon/hydrogen mixture, and the step of treatment is a reducing step.

The gas-treatment step, whatever the gas delivered, can be performed before, after, or during the deposition step.

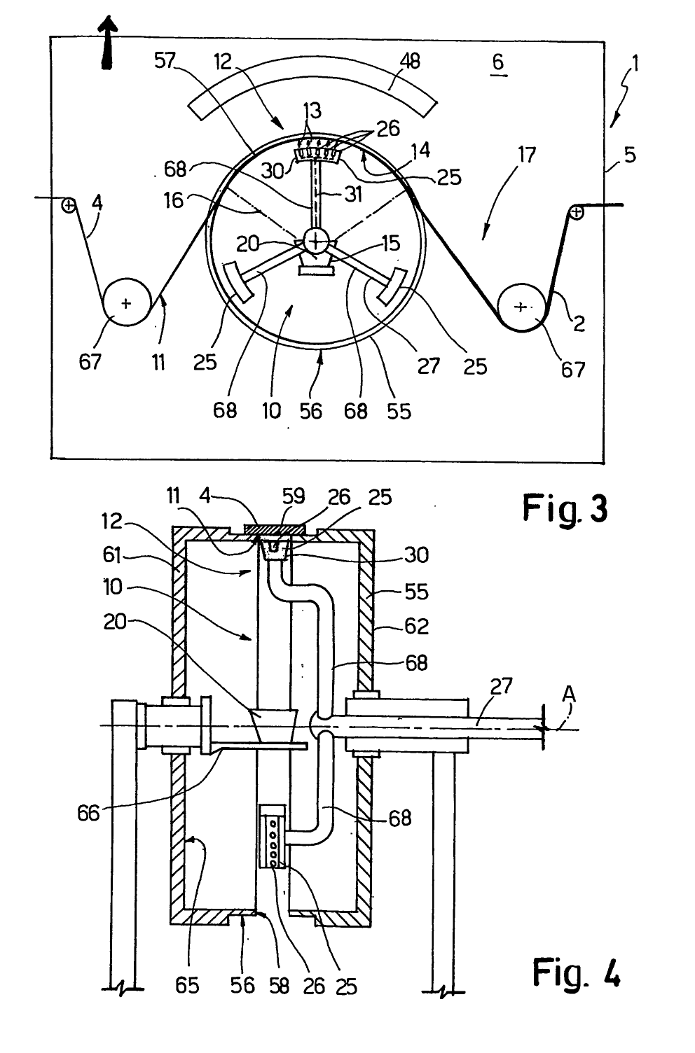

In the embodiment of FIGS. 3 and 4, in which items that are similar to, or the same as, the ones already described are designated by the same numbers, the feed means 17 define a curved path for the substrate 4 through the evaporation area 16, and the moving means 27 are designed to bring the diffuser 25 into the proximity of the face 11 of the substrate 4 and within the evaporation area 16 along a curved path radially internal to said path defined by the feed means 17.

In particular, the feed means 17 comprise a substantially cylindrical motor-driven carousel 55, which is able to rotate about a central axis A and has a radially external side surface 56, on which a longitudinal stretch 57 of the substrate 4 is wound. The surface 56 is provided with a circumferential slit 58, which is set substantially along a diametral plane of the carousel 55 for intercepting the evaporation area 16 and on which a central longitudinal strip 59 of the substrate 4 extends. The slit 58 is defined, for example, by an annular space between two wheels 61, 62, which are set alongside one another and are aligned along the axis A, and are able to rotate about the axis A.

The evaporation means 15 are set in an internal cavity 65 of the carousel 55 delimited by the wheels 61, 62. In particular, the crucibles 20 are carried by a bracket 66 that projects into the cavity 65 and are hence radially on the inside of the carousel 55 and internal to the path of the substrate 4.

Two rollers 67 are set parallel to the carousel 55, one upstream and one downstream of the carousel 55, for defining the stretch 57 of the substrate 4 wound on the carousel 55.

The moving means 27 comprise three motor-driven arms 68, which are set circumferentially at a distance of 120° from one another inside the cavity 65 and can rotate fixedly about the axis A. The arms 68 carry respective diffusers 25 provided with ultrasound-expansion nozzles 26. The diffusers 25 project axially in cantilever fashion from respective free ends of the arms 68 so as to be aligned with one another and with the slit 58.

1. A method of deposition of films of coating materials on a substrate, in particular for deposition of films of superconductive oxides and/or buffer layers of superconductive composite tapes, comprising a step of deposition of a film (2) on the substrate (4) associated to a step of gas treatment in situ, in which a flow (13) of gas is sent towards a working surface (14) of the substrate (4) or of the film (2) growing on the substrate, the method being characterized in that said gas-treatment step comprises a step of ultrasound expansion of the flow (13) of gas delivered.

2. The method according to claim 1, characterized in that the deposition step is a vacuum deposition step.

3. The method according to claim 1 or claim 2, characterized in that the gas-treatment step is performed before, after, or during the deposition step.

4. The method according to any one of claims 1 to 3, characterized in that the gas-treatment step is a step of oxygenation, the flow (13) of gas being a flow of oxygen.

5. The method according to any one of claims 1 to 3, characterized in that the gas-treatment step is a reducing step performed with forming gas, for example an argon/hydrogen mixture.

6. The method according to any one of the preceding claims, characterized in that the step of ultrasound expansion is performed via at least one ultrasound-expansion nozzle (26), through which the flow (13) of gas is delivered, said nozzle being designed to generate a delivery area (40), in which at least as far as a distance of approximately 5 mm or approximately 10 mm from the nozzle there is an oxygen pressure approximately ten times the oxygen pressure outside the delivery area.

7. The method according to the preceding claim, characterized in that said nozzle (26) has a ratio between the inlet cross section and the outlet cross section comprised between approximately 1:2 and approximately 1:20.

8. The method according to any one of the preceding claims, characterized in that the gas-treatment step is performed cyclically.

9. The method according to any one of the preceding claims, characterized in that the deposition step and the gas-treatment step are performed in a vacuum chamber (6), and the step of treatment comprises a step of pressurization of the flow (13) of gas prior to said step of ultrasound expansion.

10. The method according to the preceding claim, characterized in that, in the deposition step, the substrate (4) is carried through an evaporation area (16) formed within the chamber (6).

11. The method according to the preceding claim, characterized in that the substrate (4) is tape-shaped and is fed continuously through the evaporation area (16).

12. The method according to claim 10 or claim 11, characterized in that the substrate (4) traverses the evaporation area (16) along a substantially curved path and the evaporation area (16) is radially internal to said path.

13. An apparatus (1) for deposition of films of coating materials on a substrate, in particular for deposition of films of superconductive oxides and/or buffer layers of superconductive composite tapes, comprising a chamber (6), inside which are housed deposition means (10) for forming a film (2) of coating material on a face (11) of the substrate (4) and gas-treatment means (12) for delivering a flow (13) of gas on a working surface (14) of the substrate or of the film growing on the substrate, the apparatus being characterized in that the gas-treatment means (12) comprise at least one ultrasound-expansion nozzle (26), through which said flow (13) of gas is delivered while undergoing ultrasound expansion.

14. The apparatus according to claim 13, characterized in that said chamber (6) is a vacuum chamber.

15. The apparatus according to claim 13 or claim 14, characterized in that said nozzle (26) is designed to generate a delivery area (40), in which at least as far as a distance of approximately 5 mm from the nozzle there is an oxygen pressure approximately at least ten times the oxygen pressure in the chamber (6).

16. The apparatus according to claim 15, characterized in that said nozzle (26) has a ratio between the inlet cross section and the outlet cross section comprised between approximately 1:2 and approximately 1:20.

17. The apparatus according to any one of claims 13 to 16, characterized in that the deposition means (10) comprise evaporation means (15) for forming an evaporation area (16).

18. The apparatus according to claim 17, characterized in that the gas-treatment means (12) comprise at least one diffuser (25) provided with a plurality of ultrasound-expansion nozzles (26), and moving means (27) for bringing said diffuser (25) cyclically within the evaporation area (16).

19. The apparatus according to claim 17 or claim 18, characterized in that it comprises pressurization means (28) for feeding gas under pressure to said gas-treatment means (12).

20. The apparatus according to any one of claims 17 to 19, characterized in that it comprises feed means (17) for carrying the substrate (4) through the evaporation area (16).

21. The apparatus according to claim 20, characterized in that the substrate (4) is tape-shaped, and the feed means (17) are continuous-feed means for feeding the substrate through the evaporation area (16) continuously.

22. The apparatus according to claim 20 or claim 21, characterized in that the feed means (17) define a substantially curved path of the substrate (4) through the evaporation area (16), and the evaporation means (15) are set radially internal to said path.
